(19) United States
(12) Patent Application Publication
(10) Pub. No.: US 2009/0313285 A1
(43) Pub. Date: Dec. 17, 2009

(54) METHODS AND SYSTEMS FOR FACILITATING THE FANTASIES OF USERS BASED ON USER PROFILES/PREFERENCES

(76) Inventor: Andreas HRONOPOULOS, San Diego, CA (US)

Correspondence Address: KENYON & KENYON LLP, ONE BROADWAY, NEW YORK, NY, 10004, US

(21) Appl. No.: 12/140,069

(22) Filed: Jun. 16, 2008

(51) Int. Cl. G06F 17/00

(52) U.S. Cl. 707/102; 707/104.1; 707/E17.009

(57) ABSTRACT

Systems and methods for facilitating highly tailored and user specific fantasies are provided. Example embodiments may include building a psychological profile of a user for the purpose of providing a fantasy based result. Example embodiments may include refining a user's preferences, especially visual preferences, through a series of visual image/movie-clip sets. The user may be able to select or otherwise indicate a preferred image in the set. Example embodiments may include building a detailed profile of a user based on both the psychological profile and refined image preferences. The provided result may include highly personalized visual content, for example, fantasy based adult entertainment. The provided result may also match users with similar profiles together for the purpose of sharing content or content ratings. Additionally or alternatively, users with reciprocal profiles may be matched for the purpose of anonymous or face-to-face role playing encounters. Example embodiments of the present invention allow users to explore very specific fantasies in a number of ways based on that user's profile/preferences.

### BACKGROUND

Providing video content to users is a major industry. One way to sell more content to users or to increase the satisfaction of subscription users is to provide them content that is desirable to them, while at the same time minimizing the effort users need to spend to locate such content. For example, Amazon, Netflix, and Ebay, well-known providers of various types of goods over the Internet, including videos, all provide some sort of automatic recommendations to users. For example, recommendations may be based on a user's purchase history and/or the purchase history of demographically similar users.

The adult entertainment industry makes up a significant portion of the online economy. Specifically, digital media adult entertainment (e.g., videos, pictures, cartoons, and similar) is a multi-billion dollar industry, which makes up a substantial portion of Internet traffic and commerce. Estimated total revenues for adult videos were greater than $12 billion in 2005. See “State of the U.S. Adult Video Industry”, Business Wire, Dec. 13, 2005.

It is additionally known that sexual fantasies are a healthy part of virtually all humans beyond a certain age. See Peter Doskoch, Safest Sex, Psychology Today, September/October 1995 at 46 (also available at http://psychologytoday.com/articles/pto-1268.html). Research further indicates that fantasies of many kinds are normal and healthy. For example, even fantasies based on what would be considered socially deviant behavior are virtually never an indication of actual or future socially deviant behavior, and are quite normal. As a result, the adult entertainment industry produces videos, magazines, images, and other media geared towards specific fantasy genres. However, human fantasies are as diverse as the human population itself, and current fantasy based adult entertainment typically focuses on only one or a few attributes.

### SUMMARY

One example embodiment of the present invention is a method of determining user preferences that may include asking or otherwise determining psychological and background information about a user. Questions may include information about the user's self (e.g., age), information about the user's life (e.g., occupation), information about the user's desires, preferences, or any number of other things. One aspect of the user's preferences may include visual preferences (e.g., what characters in the user's fantasies look like). The example embodiment may refine the user's visual preferences by presenting a series of image (or movie, etc.) sets to the user. The example embodiment may then allow the user to select a preferential image from the set and optionally rate the image. In this way, example embodiments may be able to provide users with a result based on that user's psychological profile and/or visual preference selections. Other example embodiments may only use the psychological profile. Other example embodiments may use only the visual preference image sets. Some example embodiments may use both, or part of each.

The end result of example embodiments may include several things. One end result may be to provide visual content (e.g., images and/or movies) to a user. The visual content may be in the form of adult entertainment and may portray multi-variable fantasies. The use of the psychological profile and/or visual preference image sets may be used to find and deliver highly tailored and personalized adult entertainment to the user. In another example embodiment the end result may be to match a user with other users. Matching may be based on having similar psychological profiles, similar preference selection profiles, or both. The purpose may be to provide one user content rated highly by a user with a similar profile. Additional purposes are possible, such as putting matched users in communication with each other for any purpose, including discussing or recommending additional content. Additionally or alternatively, matching may be based on reciprocal profiles. A first user may like a certain type of fantasy (e.g., teacher/student) where the first user is in a first role (e.g., male student), and a second user may like the same type of fantasy (e.g., teacher/student) where the second user is in the other role (e.g., female teacher). These users, having reciprocal or complementary profiles, may be put in communication with each other for any number of purposes, including simultaneously viewing matching content, role-playing via virtual means (e.g., chat, email, virtual reality rooms, etc.), or meeting face-to-face for real-life role playing.

All of the features of example embodiments are customizable to the user's preferences and desires, including the user-to-user communication/matching feature. Other results and outcomes are possible using the psychological profile and/or visual preference refinement procedure features of example embodiments. Example embodiments of the present invention implement one or more of these novel features in methods, systems configured to run one or more of the methods, and computer readable storage mediums having instructions to execute one or more of the methods.

### BRIEF DESCRIPTION OF THE DRAWINGS

FIG. 1 is an illustration of an example procedure, according to an example embodiment of the present invention.

FIG. 2a is an illustration of a decision tree for an example procedure, according to an example embodiment of the present invention.

FIG. 2b is an illustration of the example decision tree with an illustrative decision path for the example procedure, according to an example embodiment of the present invention.

FIG. 2c is an illustration using images of a decision tree for an example procedure, according to an example embodiment of the present invention.

FIG. 3 is an illustration of an example procedure, according to an example embodiment of the present invention.

FIG. 4 is an example system, according to an example embodiment of the present invention.

FIGS. 5a-c illustrate example data structures that may be used, for example, with the example procedures and systems, according to an example embodiment of the present invention.

### DETAILED DESCRIPTION OF EXAMPLE EMBODIMENTS

Some example embodiments of the present invention relate to procedures and systems for providing highly personalized video (or other visual) content to a user, e.g., adult entertainment content tailored and/or selected based on particular user preferences and attributes. The procedures and systems may be provided in the context of an adult video provider and customers who gain access to the digital content via the Internet. The content provider may have data repositories containing a library of different videos, images, and other content. The content may be indexed and/or tagged with various descriptive information about the content and the key attributes of the content. The example procedures may then perform a multi-part analysis of the user, to accurately determine what content that user would enjoy the most. Several example steps may include, (1) building a profile of user information, (2) asking questions about user preferences, (3) asking questions about desired relationships, (4) determining the ideal location or setting, and (5) further refining the category and characteristics of the visual content desired. At the end of this detailed inquiry, a diverse library of visual content may be accessed to provide the user with highly personalized entertainment.

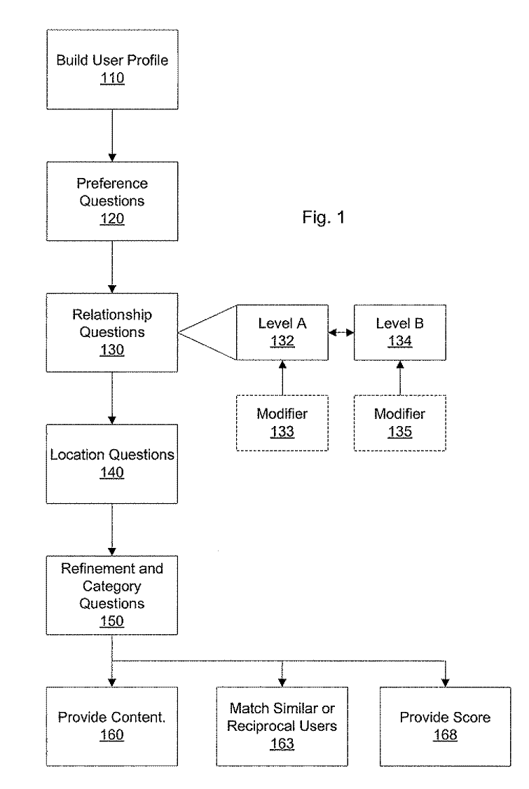

These general steps are illustrated in FIG. 1. First, at 110, an example procedure may build a user profile. This step may include asking the user questions about the user's background, characteristics, and environment. Some example questions may help illustrate the type of information gathered about a user at this stage in the profile building. Questions may include age, gender, height, weight, occupation, salary, current residence, hometown growing up, relationship status (e.g., single, married, open-marriage, divorced, etc.), parents' relationship status (e.g., still together, divorced while you were under 18, divorced after you left the house, etc.), how happy your parents are with respect to their arrangement (e.g., married but unhappy, divorced but get along, etc.), religion of parents, religion of the user, age of first sexual urges, age when the user first became sexually active, and/or age when the user first became sexually active with a partner. Some questions may depend on the answer to previous questions. For example, the user may be asked about the user's feelings about their physical attributes (e.g., “What do you think of your penis or breast size? (a) small, (b) average, (c) above average/big, (d) just right.”). Another example may include, if in a relationship, do you continue to view adult content alone, with your partner, or both. Another example may include asking if the user prefers sex within a committed relationship, or so-called “no strings attached” partners. Questions may include who raised the user, and who taught the user about sex. The example procedure may inquire, during high school, if the user was (a) popular, (b) smart, (c) athletic, (d) average, etc. Many other questions are possible, and may be relevant depending on the nature of the content to be served or other result to be provided to the user.

Some users may be reluctant to answer these questions honestly. It may be advantageous to provide the user with humorous answer choices to some or all of the questions. In this way, the user may feel more comfortable answering the questions, as compared to asking in a serious, clinical manner. Several example questions are enumerated below. However, these are only examples, and any number of additional or alternative questions are possible to assist example procedures and systems to build a psychological profile of a user.

TABLE 1
Example user/psychological questions.

| 1. | If you were at an amusement park, which would you prefer: | |
|---|---|---|
| | A. | Tunnel of Love |
| | B. | Tilt O Whirl |
| | C. | Bungee Jump |
| 2. | If you had 30 minutes of free time you would: | |
| | A. | Get something to eat, I'm starved. |
| | B. | Perhaps look at an adult magazine that's been lying around |
| | | untouched. |
| | C. | Lock the bedroom door for a nice romp in the sack. |
| 3. | During my last vacation . . . | |
| | A. | I hit up every tourist site on the map. |
| | B. | I enjoyed the sun by the pool and a great view of half naked |
| | | people. |
| | C. | I placed the “Do Not Disturb” sign on the Door. |
| 4. | When it comes to relationships, what best describes you? | |
| | A. | Yes, I want a relationship. |
| | B. | Maybe someday, for now I'm happy hunting. |
| | C. | Really, I just want casual encounters . . . no strings attached. |
| 5. | When having a conversation with someone: | |
| | A. | I listen intently. |
| | B. | I stare at their mouth/chest. |
| | C. | I start imagining sexual thoughts immediately. |
| 6. | How do you feel about fantasies? | |
| | A. | I don't really have any. |
| | B. | I live vicariously through other people's fantasies. |
| | C. | I will share mine if you share yours. |
| 7f. | My breasts are: | |
| | A. | I'm part of the itty bity titty committee. |
| | B. | Perfect . . . more than a mouthful is a waste. |
| | C. | Large and in charge. |
| 7m. | My penis is: | |
| | A. | Small but it works. |
| | B. | It's not the size of the boat, it's the motion of the ocean. |
| | C. | Dangerously big . . . don't hate me cuz I'm hung. |
| 8. | Sex in the shower sounds: | |
| | A. | Slippery and dangerous. |
| | B. | Eco-friendly so we can conserve water. |
| | C. | Like a fantasy . . . please drop the soap!! |
| 9. | Chocolate is best: | |
| | A. | As a drink, with whipped cream on top. |
| | B. | Delivered as a gift in hopes to score bonus points for later. |
| | C. | Consumed in the bedroom. |
| 10. | What lighting best sets the mood for you? | |
| | A. | Low, romantic, black as night |
| | B. | Bright as day . . . flip on the switch |
| | C. | Black lights, full lights, no lights . . . I like it all |
| 11. | Your favorite place to have sex is . . . | |
| | A. | I prefer the bedroom. |
| | B. | Mostly in the bedroom but switching it up sometimes is nice. |
| | C. | Anywhere, anytime, I'm down. |
| 12. | The last time you thought about sex was . . . | |
| | A. | About a second ago. |
| | B. | Earlier this week or last week. |
| | C. | Can't quite remember but I will get back to you. |
| 13. | Your idea of great sex is . . . | |
| | A. | A quickie . . . let's make it happen, our TV show is about to |
| | | begin. |
| | B. | A little foreplay, followed by slow, intense lovemaking. |
| | C. | An event to fill the entire evening. |
| 14. | How aggressive do you like your sex? | |
| | A. | no rough stuff but please kiss my neck. |
| | B. | a little hair pulling, nipple pinching is always nice. |
| | C. | spontaneous spankings, anything goes. |
| 15. | I like my partners to be: | |
| | A. | Quiet . . . I don't like talking. |
| | B. | Moaners, a little vocal. |
| | C. | Earth shaking screamers, lots of talking. |
| 16. | Would you invite a third party into your relationship? | |
| | A. | No, sharing isn't caring. |
| | B. | I would be willing to experiment. |
| | C. | The more the merrier. |

Next, at 120, the example procedure may ask one or more preference questions. These types of questions may be less about the user (e.g., the questions asked at 110), and more about what the user is interested in. For example, the user may be asked if he or she likes forbidden fantasies, (e.g., something that you are not supposed to do or is “socially deviant”). The user may be asked if he or she likes irresistible fantasies (e.g., spontaneous or “must have right here right now” type fantasies). The user may be asked if he or she prefers to be dominated or to dominate a relationship or sexual encounter. The user may be asked if he or she prefers a traditional fantasy (e.g., girl/boyfriend, spouse, etc).

Next, at 130, the example procedure may ask questions about relationships. This may include identifying what the social relationship between the characters portrayed in the fantasies of the user are most desirable (e.g., teacher/student or boss' wife). There are an enormous number of potential relationships that could be provided to the user. It may be best illustrated as a set of combinations, e.g., as illustrated at 132 and 134. For example, level A may include boss and co-worker, and level B may include niece, friend, and secretary. Then, any combination of these things is possible including boss's niece, boss's friend, boss's secretary, co-worker's niece, co-worker's friend, and/or co-worker's secretary. Further, examples of relationships (e.g., 132 and/or 134) include secretary, professor, coach, classmate, dorm-mate, roommate, teammate, best friend, mom, dad, sister, brother, teacher, wife, husband, ex-wife, ex-husband, girlfriend, ex-girlfriend, boyfriend, ex-boyfriend, niece, nephew, daughter, son, friend, fiancé, boss, co-worker, maid, gardener, gym member, delivery person, restaurant server, retail employee, and/or many others. These relationships may then be combined. 132 and 134 illustrate combining two relationship terms, but any number of levels are possible including just one level (e.g., my boss). Certain combinations may be less appealing, such as my dorm-mate's dorm-mate, but still possible. Other combinations may be very unappealing to some, and yet appealing to other groups of people, such as, my best friend's girlfriend. Certain combinations will likely not make sense and be skipped as options, e.g., my wife's husband. Additionally, modifying adjectives may be used for one or more of the levels (e.g., 133 and/or 135). For example, my sister's “hot” friend, my “best” friend's “hot” girlfriend, or my co-worker's “wild” wife. Adjectives such as “ex” may dramatically change the portrayed fantasy and character relationship. For example, my wife's husband does not make much sense, but my ex-wife's husband has a totally different relational implication. Also, my “best” friend's “ex-” girlfriend is significantly different than my “best” friend's girlfriend (e.g., current girlfriend) or my “ex-” friend's girlfriend. The first is frowned upon, the second is a serious breach of the friendship, and the third has a vengeful aspect to it. These are just a few illustrations of example modified relationships. Other example adjectives include sexy, cute, hot, any ethnicity, wild, best, adulterous, etc. Many examples were illustrated above, but as many possibilities of relationships and combinations of relationships as exist, or are conceivable, are possible implementations of example embodiments.

Next, at 140, the example procedure may ask about a desired location or environment for a fantasy to take place. Some locations may be far more suitable for certain relationships (e.g., those discussed with respect to 130), but any combination is possible. For example, “a locker room” may be most common for relationships based on coaches, teachers, classmates, teammates, etc. Also, a classroom may be most common for relationships based on professors, teachers, coaches, classmates, girl/boyfriend, etc. An office may be most common for a boss, co-worker, secretary, etc. based relationships. Any combination is possible though, and “My Boss's Wild Wife” may be located in a classroom or locker room instead of the office. Other example locations include the kitchen, a moving/parked car, the bathroom, the shower, the pool, the hot tub, outside, the forest, the beach, underwater, a castle, on a horse, in a cage, a warehouse, a bar, the bedroom, a restaurant, other public places, a boat, outer-space, or any other conceivable place.

Other categories of questions may be possible. For example, another attribute may be to determine a power discrepancy; such as a submissive man may be paired with a dominating woman, or vice versa and etc. Another attribute may include the clothing or prop selection (short for “theatrical property” and used to describe any object the people in the content (e.g., video or image) interact with or is otherwise independent of the people portrayed in the content). Additional attributes may include plot or story line developments, such as back stories, talking, when the characters enter, how the action progresses, what types of action occur and in what order, etc.

At 150, another information gathering step may be performed by the example procedure. This step may include gathering information about the user's preferences with regard to the specific characters. In this step, the example procedure may refine the user's visual preferences with regard to the desired fantasy. Here, things such as number of characters, gender of characters, physical attributes of characters, age, hair color, height, tattoos, piercings, and any number of other aspects of the characters may be refined.

Prior questions lent themselves to textual inquiries, but questions related to step 150 may be more visual in nature. Thus, in a further aspect of the present invention, an example embodiment of refining a user's profile may include an example procedure that uses a series of images to identify the user's (e.g., a customer's) preferences. The example procedure may use the method as a search feature each time new content is requested. Example procedures may also use the user's profile(s) (e.g., a profile built by 110-150) to alert the user that new content has been added, which matches or substantially matches the user's profile. Alternatively or additionally, multiple profiles are possible, or one profile that allows for multiple preferences are possible. For example, a user may like a certain set of content related to one category, and a set of content related to a very different category. The information about the user (e.g., 110) may remain the same, but the other preferences (e.g., 120-150) may be established in multiple sets or preference profiles. Content that “matches” the user's profile could mean an exact match, or a match above some threshold, either set by the system or the user (e.g., matched ninety percent of preferences).

To refine a user's preference profile, the example procedure may show the user a set of images. While the examples described here use still images, it may be appreciated that any representative visual content may be used in the example embodiments. For example, instead of still images the user may be shown a representative video clip (e.g., a streaming video clip, an animated gif, etc.), a cartoon, an animation, or similar. Moreover, non-visual information, e.g., answers to text queries or user demographic information may also be used to supplement the user indications based on the images. The example procedure may prompt the user to select which of the images is preferable. The user may select the preferable image in any number of ways. The procedure may have the user click on the preferable image with a point and click input device (e.g., a mouse), or the procedure may label each image with an identifier (e.g., a letter or number) and ask the user to enter that identifier on an input device (e.g., a keyboard). It may be the aim of a specific set of images and a specific preference selection to identify one specific preference. For example, the procedure may show a picture of a tall person, a picture of a short person, and a picture of a person of average height. The procedure may also indicate which attribute preference is being prompted for, especially if the attribute is not readily apparent by the images presented (e.g., “Here are several images of people of different heights, please select the most preferable height.”). The procedure may also allow a user to indicate that the user has no preference with regard to that attribute. Next, the procedure may move on to a different attribute, for example, hair color. The user may now be shown a set of images with different hair colors (e.g., blond, brunet, red, black, etc.). The images may be labeled, the user may be prompted for a selection, and the procedure may indicate what selection is being prompted for (e.g., hair length). It is not necessary, but may be preferable that the images in subsequent sets conform to the preferences indicated in prior sets. For example, if the user selected the tall person from the first set, then the second set may include various tall people with different hair colors. Likewise if the user selected the short person, the second image set may include various short people with different hair colors. The procedure may also show more than one picture for each attribute version. For example, the procedure may show eight pictures of people with long hair and eight pictures of people with short hair. This may provide more accurate results by allowing a user to focus the preference on the attribute in question by taking a sort of visual average of the images. Say for example only one picture of each hair length version was shown. The user may prefer long hair, but find the particular person in the one image of a person with long hair objectionable and the person with short hair more appealing. The user may then be inclined to select the picture of the person with short hair as preferable even though the user really does prefer long hair. If more than one image is used the user may have a better chance at making a selection which accurately reflects the user's true preference for that attribute. Additionally, the procedure may start with very obvious attributes (e.g., gender), or attributes that may be shown without having to show a lot of other attributes at the same time. Then, by implementing the feature of showing images with only the preferred attributes as indicated by preference selections in prior image sets, the selection may be more accurate as it ensures all images are generally appealing with only the attribute in question for that image set substantially differing. In this regard, several embodiments are possible.

It will be appreciated that additional features may also be included. For example, instead of merely indicating the most preferential image, the user may be asked to rate each image (e.g., from one to ten). For this, the procedure may know not only which is preferential but how much the user cares about that feature. For example, if the user rated the tall person a 9, the average height person a 9, and the short person an 8 the procedure will know the user has no preference or little preference between average height people and tall people, but a slight preference against short people. Whereas if the user rates the tall person a 9, the person of average height a 5 and the short person a 2, the procedure may know the person has a strong preference for tall people. Alternatively, the user may be asked to indicate which of the images is preferred and then also indicate how much the user cares about the attribute. For example, in addition to being provided the images from which to select a preferred, the user may be given importance options (e.g., “not important”, “slightly important”, “important”, “very important”, and “required”). Then the procedure may provide content based not only on the preferred attribute but also on the importance of that attribute. Preference and/or importance ratings are possible in all embodiments, but particularly useful in embodiments where the provided result does not necessarily need to be an exact match, but above some threshold or delivered with a “match” rating. In an alternative scheme the procedure may show the user only one image and ask the user to indicate how desirable the image is. The indication could be binary (e.g., desirable/undesirable) or with a greater degree of specificity (e.g., rated on a scale from 1 to 10).

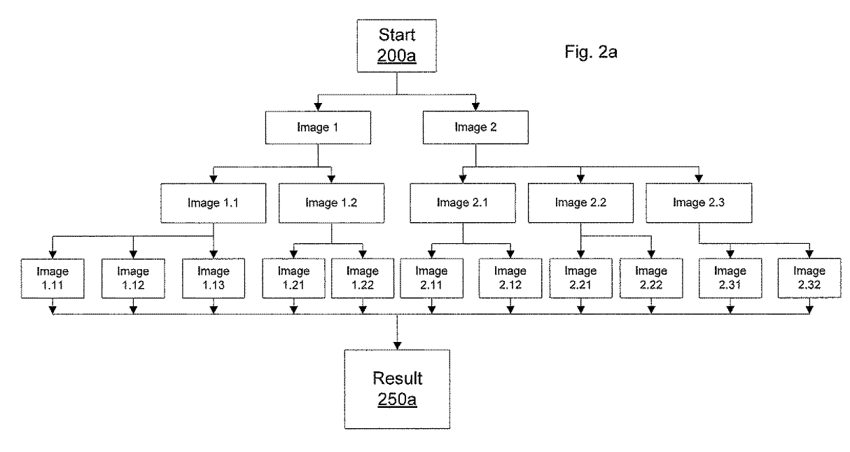

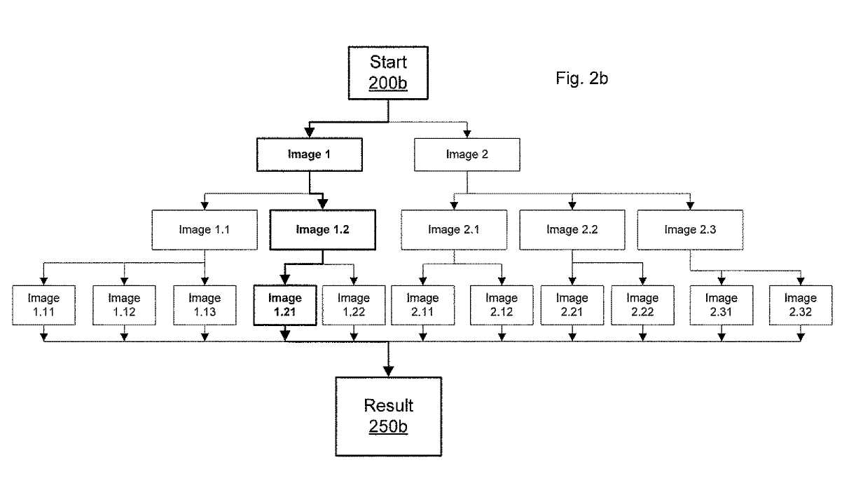

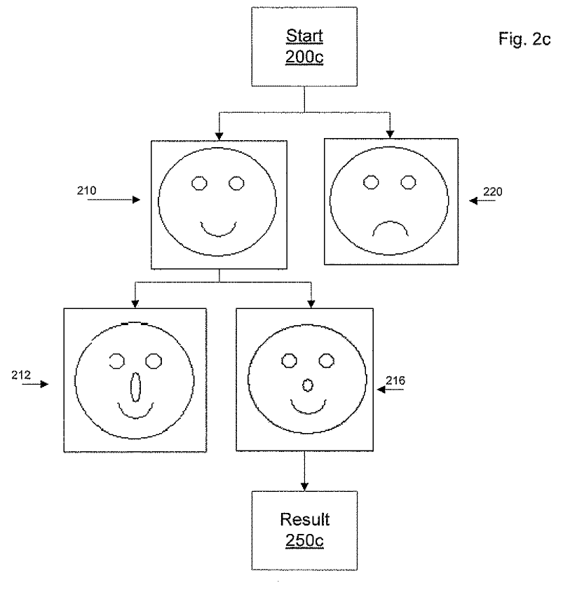

The image display aspect of example embodiments of the present invention may be further illustrated by FIG. 2a. The user may start at 200a and be presented with two images, image 1 and image 2. This is only one illustrative example, and any number of images may be shown in a set of images (e.g., six images, one for each of six attribute versions, or eight images, four for each of two attribute versions, or eleven images, five for one version of an attribute and six for another version of that attribute). After a selection is made, a new set of images is presented, e.g., either images 1.1 and 1.2 or 2.1, 2.2, and 2.3. As was discussed, this second image set may include the preferential attribute from the first image set. In other words, images 1.1 and 1.2 may both contain the key attribute version of image 1, and images 2.1, 2.2 and 2.3 may all contain the key attribute version of image 2. If the feature of presenting the preferential feature from prior selections in a subsequent image set is not implemented, then the structure of the procedure may look less like the “tree” structure illustrated in FIG. 2a, and more linear. For example if the feature is not implemented, images 2.11 and 2.12 may be identical to images 2.21 and 2.22, and identical to images 2.31 and 2.32. It may then be seen that a linear representation would be appropriate as preferences are determined on a level-by-level basis with no regard for the selection made in prior levels. This structure may simplify the design by reducing the number of images needed, and making the levels interchangeable as they are independent of each other. However, implementing the feature of having subsequent image sets depend on prior preference selections may create a more user friendly and intuitive selection process. Both of these embodiments are possible though. FIG. 2a illustrates three levels of preference selection which may end at 250a. However, any number of preference selections are possible.

FIG. 2b is similar to FIG. 2a, but shows an illustrative selection path. The darkened border and lines indicate that the user selected image 1 over image 2, image 1.2 over image 1.1, and image 1.21 over image 1.22. The result at 250b may then be a user preference profile that indicates a preference for the attributes associated with the three selected. For example image 1 may have been a female and image 2 a male, image 1.2 may have been a tall female and image 1.1 a short female, and image 1.21 may have been a blond female and image 1.22 may have been a brown haired female. The resulting user preference profile may indicate that the user prefers (and would like to be shown/served) images of tall females with blond hair. In other examples there may be an image 1.3 of an average height female. There may be an image 1.23 of a red headed tall female, or image 1.24 of a black haired tall female. It may be the case, as is indicated by image 2.3, that the decision tree may not be symmetrical. This could be because the order of attributes is different for each side, or special attributes are needed because of the prior selection. For example, while gender may be the attribute indicated at the first level, height may be at the second level under image 1, but something requiring a different number of choices (e.g., three) may be at the second level under image 2 (e.g., hair color). Alternatively, it may be the case that because of the prior selection a different number of attribute choices are provided. For example, the attribute of hair color for a female may include black/brown and blond whereas for a male it may include black/brown, blond, and bald/shaved. Bald/shaved may not be an attribute version worth offering on the female side of the decision tree and thus the number of versions for the same attribute may differ depending on a prior selection. This is just one illustration, it of course could be the case that a hair style of bald/shaved is offered on the female side as well, or any number of other attributes, versions, or combinations. It will also be appreciated that any number of attributes may be determined by a corresponding number of levels.

FIG. 2c is an illustration of a selection path with images. In FIG. 2c, the user may select image 210 over 220, i.e. the smiling face over the frowning face. The size of the face's nose is distinguished in the next level. The options beneath the frowning face are not shown because that image was not selected, but could be represented as a big nosed frown face and a small nosed frown face. The illustrated options beneath the smiling face 212 and 216 are a smiling face with a big nose and a smiling face with a small nose respectively. Result 250c, beneath image 216, indicates image 216 was selected and the result is a face with a smile and small nose.

Presenting image trees, as discussed in detail above, is one novel way of implementing the refinement and category questions 150 step of FIG. 1. Returning now to FIG. 1, at 160, 163, and/or 168, a result may be provided. These are three possible results of the example procedure, but additional results are possible. Also, the example procedure may provide one, all, or some combination of 160, 163, 168, and other possible results. The result may include providing content to the user (e.g., 160). Though an embodiment's content may include images or video, the content could be anything, but is preferably any content which is visual in nature e.g., images, video, cartoons, etc. Additionally, the example procedures and systems may determine, based on the user's background profile (e.g., 110), selections (e.g., 120-140), and further visual refinements (e.g., 150), what content the user may enjoy the most.

An alternative or additional result may include calculating, storing, and/or providing a “Naughty Score” or similar metric (e.g., at 168). Each user may be given a score based on a number of other aspects of example embodiments. For example, the user may be given an initial score and have that score adjusted based on one or more factors. For example, the user's score may be adjusted based on the answers given at 110 to 140. Additionally, the user's score may be adjusted based on the answers given at 150, and/or the refinement selections made (e.g., as described in FIG. 2a-c). Additionally, there may be another quiz or inquiry given to users specifically for creating or refining the user's score. The user's score may be adjusted based on other aspects of the example embodiments, including results related to 160 and/or 163. For example, a user may establish an initial score based on the answers given at 110 to 150. The user may then be provided content at 160, based on the established profile. However, example embodiments may monitor the content the user is viewing (e.g., both within the tailored results provided to the user and the user's browsing of the full content library). The user's score may then be adjusted based on the content viewed by the user.

Similarly, the user may be given a naughty score without even participating in the profile creation feature of example embodiments. For example, users who do not want to fill out a profile, but still browse content may be give a “Naughty Score” based solely on the content, and other user interactions with the system. Additionally, a user who is not comfortable answering all of the profile questions provided may be encouraged to answer as many as possible, or given a truncated set of questions to answer. In this way, a user's score may be based on any feature of the example embodiments, but will be more accurate and provide better results depending on the level of interaction the user provides.

Additionally, there may be a wholly independent quiz or inquiry to establish a “Naughty Score.” The independent quiz or inquiry may be given to people who are curious about their “Naughty Score,” but do not want to establish a profile or participate in the other features of the example embodiments, such as content delivery or user matching. For example, a social network application may be provided to display a social network user's score, optional explanation of the score, and invitation for other social network users to take the quiz and upon user permission/release, share their score with other associated social network users. Similar examples outside a social network context are possible, such as a website quiz that provides a result and allows a user to optionally transmit that result to selected other people, e.g., friends of the user.

Another example result of the example procedure is illustrated at 168. The example procedure may match the user with one or more other users who have matching or reciprocal preference profiles. Alternatively or additionally, the matching may be based or refined based on the users respective “Naughty Score” (e.g., as described above). As a result, the example procedures and example systems may provide the user with content that the similar users indicated was enjoyable or otherwise preferred. In addition to merely providing content to the users, the example procedure may actually connect users for social interaction. Of course, users may be able to completely control their level of privacy and anonymity. However, with the user's consent, the example procedure may allow a first user to be informed that one or more other users have similar backgrounds, naughty scores, and/or interests as the first user. These users may interact via forums, instant messages (“IM”), emails, contact information exchanges, or any other way, depending on the desires and preferences set by each user. Users may be allowed to display their real name, reveal their real name at some future time, or remain anonymous through pseudonyms and avatars (e.g., an online personality/identity).

Additionally, example embodiments of the present invention may allow a user to browse the profiles of other users. In these embodiments, a matching algorithm may still be used to suggest similar and reciprocal users, but a user may also be able to browse the profile of all users who set their privacy level to allow their profile to be browsed. Additionally, a user's “Naughty Score” (e.g., 168) may be refined by what profiles the user browses. For example, if a low scoring user almost always browses profiles of people who were given a very high score, that user's score may increase to reflect the user's interest in very high scoring users. Also, profile based adjustments may be made. For example, if a low scoring user who indicates traditional and conservative answers to the profile building questions is almost exclusively browsing the profiles of dominatrix users and/or gothic users, then that person's score may increase to reflect his or her browsing interests. Conversely, a user who answers the profile building questions in such a way to indicate a very naughty score, but subsequently browses almost all “traditional” and “conservative” profiles, may have his or her score lowered to reflect his or her interest. In this way, content browsing, profile browsing, and other interactions with the example embodiments may allow for refining of an initial score that was based on the user's profile answers.

In addition to matching similar users, the example procedure may match reciprocal users. In other words, a first user may be a male and indicate that he is interested in a fantasy about an older woman who is his professor in college. Additionally, a second user may be a female and indicate that she is interested in a fantasy about a younger man who is her student. The example procedure may inform the users that another user has a reciprocal fantasy profile, and ask if the user would be interested in being put in contact with the other user. If both agreed, the two users could engage in online role-playing, text-chat/email/IM/phone-chat, or if desired, exchange actual contact information for in-person role playing. In this aspect, especially when a preference or desire for face-to-face encounters is specified, the users may be able to select between a preference match and a background match. For example, some users may desire a teacher, and want to be matched with a user who desires a student. Alternatively, the user who desires a teacher, may only want to be matched with a user who actually is a teacher. The first, would be indicated by the second user's preferences (e.g., prefers a fantasy about a student), whereas the second may be indicated by the second user's background (e.g., occupation=teacher). Also, a combination of these may be possible (e.g., must be a teacher and desire fantasies about teacher/student encounters). This may be indicated for each attribute, as some attributes may be more acceptable as a role or more of an actual requirement. For example, a male user may not care if another user's actual profession is not a teacher, but may care if the other user is not actually a woman. It may be observed that some attributes (e.g., occupation) are easily played as a role, whereas other attributes (e.g., gender) are not as easy. This, of course, may only be the requirement or preference of some users, and some users may care more about real-life occupation than the other user's real-life gender. Additionally, the example procedure may refine the reciprocal match by comparing the “Naughty Score” of both users, and ensuring a similar score (e.g., similar level of “naughtiness”).

Users may be able to configure their user matching preferences. The example procedure may ask a user if that user is interested in knowing about one or more matching/reciprocal users, or the user may configure their account to prevent such inquiries. Also, the user may set their account to automatically provide their contact information (either real life information or anonymous avatar information) to matching users. The example procedure may also ask about the physical attributes of the user at 110, so that that user may be matched with users who desire those physical attributes in their fantasy partner.

In addition to providing content and matching users for interaction, the example procedure may do both. Users may be able to watch the same content over the internet together, while interacting through chat, voice, video, or any other means. Additionally, watching together may include simultaneously (e.g., at the same time or substantially the same time) viewing media (e.g., streaming video) over a network (e.g., the Internet). The simultaneous viewing may be implemented in any number of ways known in the art, such as, for example, buffered or unbuffered streaming video, simultaneous downloading, broadcast signals, or any other data transmission method. This mutually viewed content may be the basis for the users' entertainment (e.g., the provided result of 160/163/168), or may be a conversation piece to assist in discussions about future role-playing interactions with each other.

In addition to providing both content and matching, example embodiments of the present invention may only provide one of the two results. For example, users may desire to have content delivered, but have no interest in meeting, communicating, or otherwise interacting with other users of an example embodiment. Additionally, some users may want to have their “Naughty Score” determined and profile generated to meet other users and browse other user's profiles. These users may want to interact with other users at one or more levels, but have no interest in receiving content (e.g., as described above). In this respect, example embodiments of the present invention may provide content delivery without any user connections, may provide user matching/connections without any content delivery, or may provide a combination of the two. Additionally, profiles and “Naughty Scores” may be provided in connection with either or both of these results.

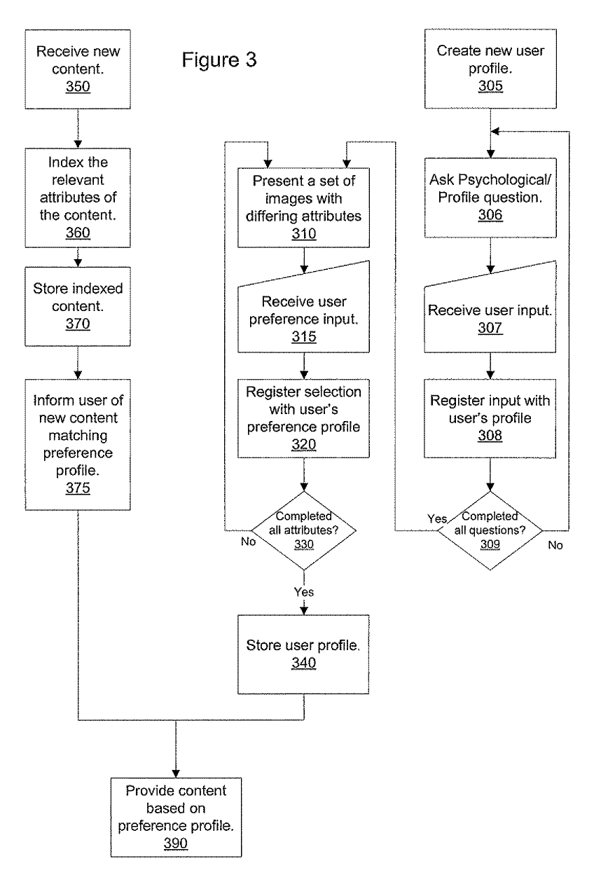

FIG. 3 is another illustration of how an example embodiment of the present invention might be implemented. FIG. 3 shows two related procedures. The first relates to the content procedure. Starting at 350 the procedure may receive new content. This could be when the example procedure is first set up and all existing content is being added to the procedure, or it could be when the procedure is already running and a new piece of content has become available. Next at 360, the procedure will index the relevant attributes. For example, if the relevant attributes are hair length, hair color, and gender, and the content is an image of a female with long brown hair, the procedure will indicate those attributes (e.g., hair length=long, hair color=brown and gender=female). At 370, the procedure may now store the content and attribute index. The attribute index may be stored with the actual content on the same repository. Alternatively, the attribute index may be independent of the content, with a pointer or other marker, and may be stored on the same or a different repository. At this point (375), the procedure may access the data repository which holds the stored user profiles (see 340 below), and inform those users whose preference profile matches (or substantially matches) the attributes of the new content that there is new matching content. Finally, at 390, the new content which matches the preference profile is served to the user.

The user profile procedure may begin at 305. A profile creation (e.g., building) may begin with questions about the person or group that will be the user. Some example questions (e.g., gender, occupation, age, etc.) were discussed above (e.g., at 110). At 306, a psychological or profile question may be asked. At 307, the user may enter an input (e.g., choosing from among options, entering text, etc.). At 308, the input may be registered with the profile. At 309, the procedure may return to 306 if more questions are required, and if not, may move on to the visual preference selection portion to refine, extend, and enhance the user's preference profile. At 310, the user may be shown a set of images with differing attributes (e.g., FIG. 2a-c). From those images the user may select a preferential image at 315. At 320, the procedure may store the selection of the preference to the user's profile. The procedure may write the result directly to the permanent profile, the procedure may store the profile in a run-time context until the profile as a whole is ready to be stored, or a combination of the two. At 330, the procedure decides if there are more attributes to test a preference for. The procedure may then repeat until all the relevant attributes are tested and preferences stored. How this may work, and the different ways 310 to 320 may work were described in more detail with regard to FIGS. 2a-c. At 340, when the user profile is complete, it may be stored. It may have been stored and updated after each iteration of 310 to 320, but may be stored at 340 in its completed state. The user profile may reside on the same repository as the content or may have its own profile repository. Once the profile is set, at 390 the procedure may provide the content which matches that user's profile. Other results are possible, e.g., as was discussed above with regard to 163 and 168.

FIGS. 2a-c are simple illustrations of how the decision (e.g., profile creation or result generation) process may work, and FIG. 3 is an illustration of how the procedure may work for profile generation and content indexing. Returning to the embodiment of an adult entertainment provider, it may be seen how useful the refinement procedure is in determining the visual preferences of a user by using visual images for the purposes of selecting visual content results. As was mentioned, any number of layers to the decision process are possible to refine a user's preference profile with regard to any number of attributes. One attribute may be the number of people portrayed in the content, and the gender of each participant. For example, preferences may include two males, two females, a male and female, a male and two females, a female and two males, a female and ten males, or any other amount and combination including a person and one or more animals. Additionally, the physical attributes of one or more people present in the content may be selectable. Those attributes may include the person's age or approximate age, ethnicity, hair color, hair length, body size, body type, breast type, breast size, penis size, or whether a certain body part has undergone a medical transformation such as a breast augmentation or circumcision. Each person in the image or video may have their physical attributes customizable. So for example, a female of one ethnicity may be paired with a male of another ethnicity. Another example may be a college-aged male (e.g., 21-25) paired with an older woman. Any combination of the attributes is possible to create highly personalized attribute sets and refine user preference profiles.

As an alternative to the location questions of 140, location preferences may also be selected or further refined by an image tree similar to that described with regard to FIGS. 2a-c. Alternatively, a series of location images may be shown as part of 140 in a linear, tree, or any other arrangement. Images depicting different relationship roles may be used as an alternative or in conjunction with the relationship questions of 130.

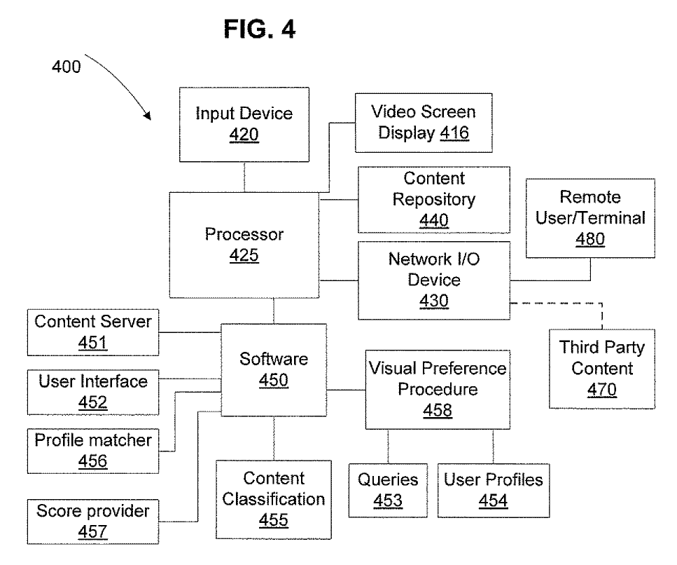

FIG. 4 is an illustration of an example embodiment of a system that may be configured to perform one or more of the procedures described above. System 400 may have a processor 425. The processor could be any number of things including for example one or more computer processors. The processor is in communication with an input device. The input device could be any number of things including a keyboard, touch-screen, mouse, joystick, or other input device. The input device may be used by the content provider to control the system, or the input device may be used by a user to ran the procedure, 458. Alternatively, the system 400 and input device 420 may be part of a system operated only by the content provider, and a remote user 480 may access the system via a network (e.g., the Internet) and the system Network I/O device 430. This alternative arrangement would be typical in an arrangement where remote users accessed a content provider's content via the Internet and web-pages. The system 400 may also have a video screen display 416, which like the input device, may be used directly by the user (e.g. customer) or only by the content provider while the user's display is part of a remote terminal 480. The system 400 may have one or more content repositories 440 which may hold all or some of the content served by the system 400. The system 400 may also have access to third party content 470 via the Network I/O device 430 and a network (e.g., the Internet). The system 400 may have software 450 which may reside in memory and may include any number of things including an operating system, various utilities and applications. The software 450 may also include the Visual Preference Procedure 458, a software embodiment similar to the embodiments which were described in previous figures. This software 450 in conjunction with processor 425 may cause the display 416 to display image based preference selections to a user. Alternatively, the Visual Preference Procedure 458 in conjunction with processor 425 may transmit in a communications protocol (e.g. http, ftp, https, tcp/ip, etc) via the Network I/O Device 430 the image sets shown to the user at the remote terminal 480, and have the user selections transmitted back to the system 400. Software 450 may contain a content server 451. The Content Server 451 may be in communication with the Content Repository 440 and/or Third Party Content 470, and may serve content according to the above described procedures from those repositories. Software 450 may have a User Interface 452 which may be used in conjunction with Visual Preference Procedure 458. Software 450 may have a Content Classification 455 component. This component may be responsible for inventorying the various relevant attributes of the content accessible by system 400. Software 450 and the Visual Preference Procedure 458 may have a Queries 453 unit responsible for making the specific queries about visual preference profiles to the user. Software 450 and the Visual Preference Procedure 458 may have a User Profiles 454 component, which may be responsible for building, storing in memory or another repository, and managing the user profiles built by the various Software 450 components. The example system may have a profile matcher 456 to facilitate the matching of similar or reciprocal users. The example system may have a score provider 457 to calculate and refine a user's score (e.g., as described above).

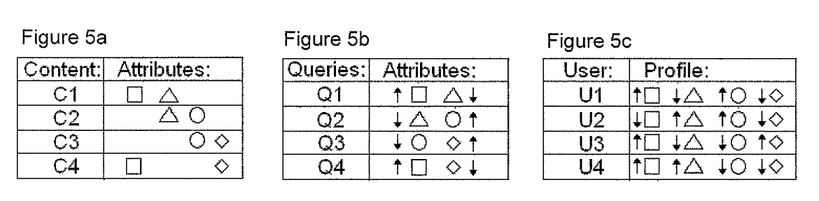

FIG. 5 illustrates another example embodiment of present invention. In FIG. 5a an illustration of four pieces of content, C1-4, is shown. Each piece of content has certain attributes. For example C1 contains the attributes of a square and by a triangle, whereas C2 contains the attributes of a triangle and a circle. In FIG. 5b an illustration of queries is shown. For example, at Q1 a user may be shown a square and a triangle and asked which is preferable. As is indicated by an up arrow for the square and a down arrow for the triangle the user may have indicated a square preference over triangles. Now in FIG. 5c an illustration of user profiles is shown. For example, after the queries user 1 (i.e. U1) may have the profile displayed in FIG. 5c. Of course this is just one simple representation, instead of binary up or down arrows, a number could be used to store relative preferences for each attribute, as was discussed in greater detail for previous figures. This illustration shows that after a series of queries (e.g., 5b) is used to refine a user profile (e.g., 5c), then content matching that profile (e.g., 5a) may be served to the user. In this illustration user 2 (i.e. U2) likes triangles and circles, and so C2 may be the best content for that user.

The result of the procedure could be a user preference profile or set of profiles used to find content meeting the user's preferences or alert the user of new content which meets one or more of the user's profiles (e.g., as determined by background, a derived psychological profile, selections, and preference refinement). Alternatively, the procedure could be implemented as a visual based search engine, never actually storing a set of preferences, but delivering content based on an iteration of the procedure. The procedure may deliver exact matches, or may give content a match rating and deliver content above a certain rating. The threshold rating may be set by the system, content provider, or user, and may be adjustable. The example procedure may return all known content and order the content according to a match rating. The example procedure may be implemented by one party and the content delivered by the procedure may be the content served by that first party, may be content served by one or more other parties, or a combination of the two. Additionally, the information gathered by the example procedure of FIG. 5 could be used to assist in matching users with other users. The matching may be based on similar fantasy profiles/preferences or reciprocal profile/preferences.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods and procedures.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

1. A method, comprising:
receiving a first plurality of answers to a first plurality of questions related to a user;
receiving a second plurality of answers to a second plurality of questions related to a plurality of preferences of the user;
building a profile of the user based at least in part on the first plurality of answers, and based at least in part on the second plurality of answers related to the plurality of preferences; and
providing the user a result, based at least in part on the user profile.

2. The method of claim 1, wherein the result includes adult entertainment.

3. The method of claim 1, wherein the first plurality of questions related to the user includes at least one of: gender, geographic location, occupation, salary, net financial worth, age, demeanor towards a desired gender, experience level, and relationship status.

4. The method of claim 1, wherein user preferences relate to a user's fantasies, and wherein the second plurality of questions related to the plurality of preferences of the user includes, with respect to the user's fantasies, at least one of: physical attributes of people, physical attributes of locations, location contexts, plot development, number of people, gender of the one or more persons, clothing, theatrical property, story line, and relationship of the people.

5. The method of claim 4, wherein physical attributes of people includes at least one of age, ethnicity, hair color, hair length, body size, body type, height, breast type, breast size, and whether the people have undergone a breast augmentation;
wherein location contexts include at least one of an office, a classroom, a living room, a bedroom, a bathroom, a kitchen, a boat, outdoors, an airplane, a car, a beach, a public place, a dorm room, and any theme specific location; and
wherein the relationship of the people includes at least one of a gender ratio of the people in a group, age discrepancy, ethnic discrepancy, domination discrepancy, and social status or context roles which include at least one of student/teacher, employer/employee, maid/resident, peers, friends of peers, service contractor/resident, and strangers.

6. The method of claim 1, wherein providing the user a result includes matching the user with one or more other users.

7. The method of claim 6, wherein providing the user a result includes calculating a metric based at least in part on the profile of the user, and wherein the matching is based at least in part on the metric.

8. The method of claim 6, wherein the matching is based at least in part on similarity between the profile of the user and one or more profiles of the one or more other users.

9. The method of claim 8, further comprising:
receiving, from a plurality of users, indications that visual content is liked by a respective user from the plurality of users; and
providing visual content to a user, wherein the visual content was indicated as liked by another use, wherein the user and the another user have matching profiles.

10. The method of claim 8, wherein two or more users, having matching profiles, are provided means for communicating with each other.

11. The method of claim 6, wherein the matching is based at least in part on a reciprocity between the profile of the user and one or more profiles of the one or more other users.

12. The method of claim 11, wherein two or more users having matching profiles are provided means for communicating with each other.

13. The method of claim 11, wherein two or more users having matching profiles are provided means for acting out a reciprocal fantasy.

14. The method of claim 6, wherein one or more users having matching profiles are provided means for viewing visual media simultaneously.

15. The method of claim 1, wherein providing the user a result includes calculating a metric based at least in part on the profile of the user.

16. The method of claim 1, further comprising:
repeating, for each user of a plurality of users, all of the receiving of the first plurality, the receiving of the second plurality, and the building of the profile; and
receiving input from a user indicating a desire to browse a profile of one or more other users.

17. The method of claim 16, further comprising:
calculating a metric for each user based at least in part on the profile of the respective user; and
refining the metric based at least in part on the input received from the user.

18. The method of claim 1, wherein the providing the user a result includes providing the user a plurality of units of media content; and further comprising:
receiving input from a user indicating a desire to browse at least one unit of the media content;
calculating a metric for the user based at least in part on the profile of the user; and
refining the metric based at least in part on the input received from the user.

19. A method of determining user preferences, comprising:
presenting a user a first image set where at least one attribute of at least one image is different than the same attribute in at least one other image in the first image set;
receiving a first evaluation from the user for the first image set;
presenting at least one subsequent second image set where at least one attribute of at least one image is different than the same attribute in at least one other image in the second image set wherein the second image set is at least in part different from the first image set;
receiving a subsequent evaluation from the user for the second image set; and
providing the user a result which depends at least in part on the evaluations of the first and second image sets.

20. The method of claim 19, wherein the evaluations of the first and second image sets include selections of respective preferable images from the first and second image sets.

21. The method of claim 19, wherein the evaluations of the first and second image sets include respective ratings of the first and second image sets as a whole.

22. The method of claim 19, wherein the image sets include one or both of still images and moving video.

23. The method of claim 19, wherein the first evaluation includes a rating for at least one of the first image set as a whole and all of the individual still images in the first image set.

24. The method of claim 19, wherein the evaluation of the first image set includes a selection indicating which of the more than one images in the first image set is preferable to the user.

25. The method of claim 19, wherein the result includes video content chosen based at least in part on the user evaluations of the first and second image sets.

26. The method of claim 19, further comprising:
presenting a user a plurality of questions, wherein the questions solicit information about the user; and
receiving an input for each of the plurality of questions, and wherein the result provided depends at least in part on the input for each of the plurality of questions.

27. The method of claim 26, wherein the plurality of questions includes questions related to one or more of the group including: gender, geographic location, occupation, salary, net financial worth, age, demeanor towards a desired gender, experience level, and relationship status.

28. The method of claim 19, further comprising:
calculating a metric associated with the user, wherein the metric is based at least in part on the first evaluation and the second evaluation.

29. The method of claim 28, further comprising:
receiving feedback based at least in part on the user's interaction with the provided result; and
refining the metric based at least in part on the received feedback.

30. A method of determining user preferences, comprising:
presenting a user with a series of image sets;
wherein for each image set at least one attribute of at least one image in the set is different from the same attribute in at least one other image of that set of images;
receiving a plurality of preference selections, at least one selection for each set in the series of image sets; and
providing the user media content based at least in part on the preference selections made.

31. The method of claim 30, wherein the preference of a first attribute is selected from a presented image set, and were all images presented in at least one subsequent set of images have the preferential version of the first attribute if the first attribute is present in the image.

32. The method of claim 30, wherein attributes include at least one of physical attributes of people, physical attributes of locations, location contexts, plot development, number of people, gender of the one or more persons, clothing, theatrical property, story line, and/or relationship of the people.

33. The method of claim 32, wherein physical attributes of people includes at least one of the actor's age, ethnicity, hair color, hair length, body size, body type, height, breast type, breast size, and/or whether the actor has received a breast augmentation;
wherein location contexts include at least one of an office, a classroom, a living room, a bedroom, a bathroom, a kitchen, a boat, outdoors, an airplane, a car, a beach, a public place, a dorm room and/or any theme specific location;
wherein the relationship of the people includes at least one of the actors' gender ratio in the group, age discrepancy, ethnic discrepancy, domination discrepancy, and/or social status or context roles which include but are not limited to student/teacher, employer/employee, maid/resident, peers, friends of peers, service contractor/resident, and/or strangers; and
wherein selecting a preference for the attribute of the gender of the one or more persons includes selecting a preference of the gender of each role in the social status or context roles.

34. The method of claim 30, wherein media content includes images, video, or any other visual media content.

35. The method of claim 30, wherein providing includes selecting from a media content repository all media content containing at least some of the preferential attributes selected by the user.

36. The method of claim 30, wherein providing includes presenting all available media content ranked in order of similarity to the preferential attributes selected by the user.

37. The method of claim 30, further comprising:
prompting the user as to which one or more attributes will be determined by the preference selection of the current image set.

38. The method of claim 30, further comprising:
providing a “no preference” option for each image set.

39. The method of claim 30, further comprising:
receiving an indication of how important a specific preference selection is to the user.

40. The method of claim 39, wherein the providing is based at least in part on the importance indication.

41. The method of claim 30, further comprising:
receiving a preference rating for each presented image in a particular image set.

42. The method of claim 30, further comprising:
indexing at least some available media content, wherein indexing includes indicating which version of at least one relevant attribute is contained in each piece of media content being indexed.

43. The method of claim 42, wherein available media content includes the media content provided by an adult entertainment provider.

44. A method of determining user preferences, comprising:
presenting a user with a series of image sets,
wherein for each image set at least one attribute of at least one image in that set is different from the same attribute in at least one other image of that set of images,
wherein attributes include at least one of physical attributes of people, physical attributes of locations, location contexts, plot development, number of people, gender of the one or more persons, clothing, theatrical property, story line, and/or relationship of the people,
wherein physical attributes of people includes at least one of age, ethnicity, hair color, hair length, body size, body type, height, breast type, breast size, and/or whether the actor has received a breast augmentation,
wherein location contexts include at least one of an office, a classroom, a living room, a bedroom, a bathroom, a kitchen, a boat, outdoors, an airplane, a car, a beach, a public place, a dorm room and/or any theme specific location,
wherein the relationship of the people includes at least one of the actors' gender ratio in the group, age discrepancy, ethnic discrepancy, domination discrepancy, and/or social status or context roles which include at least one of student/teacher, employer/employee, maid/resident, peers, friends of peers, service contractor/resident, and/or strangers,
wherein selecting a preference for the attribute of the gender of the one or more persons includes selecting a preference of the gender of each role in the social status or context roles;
prompting the user as to which one or more attributes will be determined by the preference selection of the current image set;
receiving a selection of which version of the attribute is preferable for each set in the series of image sets;
receiving an indication of how important a specific preference selection is to the user;
providing a “no preference” option for each image set,
wherein the preference of a first attribute is selected from a presented image set, and were all images presented in at least one subsequent set of images have the preferential version of the first attribute if the first attribute is present in the image;
providing the user media content based at least in part on the preference selections made and the importance indication made, wherein media content includes images, video, or any other visual media content, wherein the providing includes selecting from a media content repository all media content containing at least some of the preferential attributes selected by the user, ranked in order of similarity to the preferential attributes selected by the user.

45. A system for providing content to users based on user preferences, comprising:
a data repository configured to contain and serve media content;
a processor in communication with a data repository;
a display in communication with the processor,
the processor configured to cause the display to present a first image set where at least one attribute of at least one image is different than that same attribute in at least one other image in the set;
an input device configured to receive a first selection from the user indicating which image of the image set is the preferable image;
the processor configured to cause the display to present at least one subsequent image set where at least one attribute of at least one image is different than that same attribute in at least one other image in the set;
wherein the subsequent set is at least in part different from the first set; and
wherein the content of the subsequent image set is based at least in part on the first selection;
the input device configured to receive a subsequent selection from the user based on which image of the subsequent image set is the preferable image; and
the data repository configured to provide the user media content which depends at least in part on the selections made.

46. The system of 45, wherein attributes include at least one of physical attributes of characters, physical attributes of locations, location contexts, plot development, number of people, gender of the one or more persons, clothing, theatrical property (i.e. “props”), story line, and/or relationship of the people.

47. A method, comprising:
asking a user a first plurality of questions related to the user;
receiving a first plurality of answers to the plurality of questions;
asking a user a second plurality of questions related to a plurality of preferences of the user;
receiving a second plurality of answers to the second plurality of questions;
building a profile of the user based at least in part on the first plurality of answers, and based at least in part on the second plurality of answers related to the plurality of preferences;
refining the profile of the user with respect to the plurality of preferences by:
presenting a user with a series of image sets;
wherein for each image set at least one attribute of at least one image in that set is different from the same attribute in at least one other image of that set of images;
receiving a selection of which version of the attribute is preferable for each set in the series of image sets; and
providing the user a result, based at least in part on the user profile.

48. The method of claim 47, wherein the result includes adult entertainment.

49. The method of claim 47, wherein the first plurality of questions related to the user includes at least one of: gender, geographic location, occupation, salary, net financial worth, age, demeanor towards a desired gender, experience level, and relationship status.

50. The method of claim 47, wherein user preferences relate to a user's fantasies, and wherein the second plurality of questions related to the plurality of preferences of the user includes, with respect to the user's fantasies, at least one of: physical attributes of people, physical attributes of locations, location contexts, plot development, number of people, gender of the one or more persons, clothing, theatrical property, story line, and relationship of the people.

51. The method of claim 50, wherein physical attributes of people includes at least one of age, ethnicity, hair color, hair length, body size, body type, height, breast type, breast size, and whether the people have undergone a breast augmentation;
wherein location contexts include at least one of an office, a classroom, a living room, a bedroom, a bathroom, a kitchen, a boat, outdoors, an airplane, a car, a beach, a public place, a dorm room, and any theme specific location; and
wherein the relationship of the people includes at least one of a gender ratio of the people in a group, age discrepancy, ethnic discrepancy, domination discrepancy, and social status or context roles which include at least one of student/teacher, employer/employee, maid/resident, peers, friends of peers, service contractor/resident, and strangers.

52. The method of claim 47, wherein providing the user a result includes matching the user with one or more other users.

53. The method of claim 52, wherein providing the user a result includes calculating a metric based at least in part on the profile of the user, and wherein the matching is based at least in part on the metric.

54. The method of claim 52, wherein the matching is based at least in part on similarity between the profile of the user and one or more profiles of the one or more other users.

55. The method of claim 53, further comprising:
receiving an indication that visual content is liked by a user; and
providing visual content to a user, wherein the visual content was indicated as liked by another use, wherein the user and the another user have matching profiles.

56. The method of claim 54, wherein two or more users having matching profiles are provided means for communicating with each other.

57. The method of claim 52, wherein the matching is based at least in part on a reciprocity between the profile of the user and one or more profiles of the one or more other users.

58. The method of claim 57, wherein two or more users having matching profiles are provided means for communicating with each other.

59. The method of claim 57, wherein two or more users having matching profiles are provided means for acting out a reciprocal fantasy.

60. The method of claim 52, wherein one or more users having matching profiles are provided means for viewing visual media simultaneously.

61. The method of claim 47, further comprising:
calculating a metric, wherein the metric is based at least in part on the user profile and the selection for each of the image sets.
